(19) United States
(12) Patent Application Publication
(10) Pub. No.: US 2015/0225253 A1
(43) Pub. Date: Aug. 13, 2015

(54) METHOD FOR PREPARING BASIC ZINC CHLORIDE

(71) Applicant: Shenzhen Hazardous Waste Treatment Station Co., Ltd., Shenzhen (CN)

(72) Inventors: Zhichuan CHEN, Shenzhen (CN); Anzhang MAO, Shenzhen (CN); Yinliang ZHANG, Shenzhen (CN); Xiaowen LIU, Shenzhen (CN); Jun LI, Shenzhen (CN); Zhaoan ZHOU, Shenzhen (CN); Chunhua LIAO, Shenzhen (CN); Juan PENG, Shenzhen (CN)

(21) Appl. No.: 14/695,262

(22) Filed: Apr. 24, 2015

Related U.S. Application Data
(63) Continuation of application No. PCT/CN2013/074031, filed on Apr. 10, 2013.

(30) Foreign Application Priority Data
Mar. 11, 2013 (CN) 2013100759309

(51) Int. Cl. C01G 9/04

(52) U.S. Cl. CPC C01G 9/04

(57) ABSTRACT

A method for preparing basic zinc chloride is provided. The present invention relates to a method for preparing basic zinc chloride, and particularly to a method for preparing feed additive basic zinc chloride. An objective of the present invention is to provide a low-cost, safe and environment-friendly method for preparing basic zinc chloride, and the method is characterized in that basic zinc chloride is prepared from zinc chloride and calcium hydroxide through reaction. According to the present invention, basic zinc chloride is successfully prepared by using zinc chloride and calcium hydroxide through reaction for the first. The method is simple, the process is short, the reaction costs are low, and the wastewater generated during reaction can be easily treated and is safe and environmentally friendly. The zinc content, the chlorine content, the arsenic content, the lead content and the cadmium content in the finished basic zinc chloride prepared by the method of the present invention fully comply with national standards for feed grade basic zinc chloride, so the finished basic zinc chloride prepared by the method of the present invention can be directly used as feed additive.

### BACKGROUND

1. Technical Field

The present invention relates to a method for preparing basic zinc chloride, and particularly to a method for preparing feed additive basic zinc chloride.

2. Related Art

Zinc, presenting in all animal tissues and organs, has the functions of promoting the rapid regeneration of taste bud cells of the tongue mucosa and whetting the appetite, and is an essential elements for animals. Common zinc sources generally used in feeds are zinc sulfate and zinc oxide, but the absorption and utilization of zinc sulfate and zinc oxide in animal body is low. Basic zinc chloride is a new pharmacological feed additive, and has the antibacterial and anti-diarrhea effect. Compared with conventional inorganic zinc salts such as zinc sulfate and zinc oxide, basic zinc chloride has the advantages of high chemical stability, low dosage, good palatability, being safe and nontoxic, high utilization and good fluidity, and moreover, basic zinc chloride can be used to partially replace antibiotics and has no pollution the environment. Existing methods for preparing basic zinc chloride include the following: 1. Preparation from zinc oxide and zinc chloride through reaction; 2. preparation from waste zinc and a saturated zinc chloride solution through reaction; 3. preparation from zinc oxide and hydrochloric acid through reaction; 4. preparation from basic zinc carbonate and hydrochloric acid through reaction; 5. preparation from sodium hydroxide or ammonium hydroxide and zinc chloride through reaction; 6. preparation from zinc hydroxide and zinc chloride through reaction. However, the methods generally have the disadvantage of high preparation costs, and moreover, byproducts obtained by some methods easily cause environmental pollution, and the treatment costs of wastewater generated by some reactions are high.

### SUMMARY

In order to overcome the disadvantages in the prior art, an objective of the present invention is to provide a low-cost, safe and environment-friendly method for preparing basic zinc chloride.

In order to achieve the objective, the present invention provides a method for preparing basic zinc chloride from zinc chloride and calcium hydroxide from a reaction, and the reaction equation is as follows:

5ZnCl₂+4Ca(OH)₂+H₂O=ZnCl₂.4Zn(OH)₂.H₂O↓CaCl₂

The zinc precipitation rate can be ensured by appropriately increasing the reaction temperature, so the reaction temperature of the reaction for preparing basic zinc chloride is preferably 20° C. to 100° C.; an excessively low pH value is not conducive to the generation of basic zinc chloride, while an excessively high pH value will influence the main content of zinc and chlorine, thereby influencing the quality of product, so the pH value is preferably 4 to 7.

Furthermore, the reaction temperature for preparing basic zinc chloride is 40° C. to 100° C., and the pH value is 5 to 6.

Preferably, in the reaction for preparing basic zinc chloride, the molar ratio of zinc chloride and calcium hydroxide is 4.5 to 5.5:4.

Preferably, zinc chloride useful in the reaction is a zinc chloride solution having a zinc concentration of 10 to 200 g/l.

Furthermore, zinc chloride useful in the reaction is a zinc chloride solution having a zinc concentration of 50 to 150 g/l. If the concentration is excessively low, the amount of the mother solution is excessive, and the energy consumption of the reaction is increased; if the concentration is excessively high, the viscosity is too high, the reaction is not smooth, the recovery of zinc is decreased, and the quality of product will be influenced to a certain degree.

Furthermore, in order to reduce the costs, the zinc chloride solution useful in the reaction may be obtained from a zinc-containing industrial waste through hydrochloric acid leaching and removal of impurities. The zinc-containing industrial waste is also referred to as waste zinc material, includes, for example, zinc oxide ash, zinc dross, waste zinc powder and other industrial wastes. Zinc chloride can be obtained directly from the waste zinc material through hydrochloric acid leaching, and the zinc chloride solution after removal of impurities can be directly used for preparing basic zinc chloride of the present invention.

Preferably, calcium hydroxide useful in the reaction is a calcium hydroxide suspension having a mass fraction of calcium hydroxide of 3% to 60%.

Furthermore, calcium hydroxide useful in the reaction is a calcium hydroxide suspension having a mass fraction of calcium hydroxide of 10% to 20%. If the concentration is excessively low, the amount of the mother solution is excessive, and the energy consumption of the reaction is increased; if the concentration is excessively high, the reaction is excessively fast, the pH value cannot be easily controlled, and the particles are very fine, which influences the filtration performance and mobility of the product.

Furthermore, in order to reduce the costs, calcium hydroxide useful in the reaction suspension may be a calcium hydroxide suspension obtained from hydrated lime or quick lime through slaking, purification, separation and removal of residues, or the calcium hydroxide suspension is an intermediate product of the production of precipitated calcium carbonate.

### Beneficial Effects

Compared with the prior art, in the present invention, basic zinc chloride is successfully prepared by using zinc chloride and calcium hydroxide through reaction for the first. The method is simple, the process is short, the reaction costs are low, and the wastewater generated during reaction can be easily treated and is safe and environmentally friendly. Additionally, compared with other similar raw materials, calcium hydroxide has a low price, the cost of raw materials is reduced, and moreover, the reactant used for the method of the present invention may be a waste zinc material, the product of lime slaking and the intermediate product of the production of precipitated calcium carbonate, so that the wastes can be reused, and at the same time, the costs for preparing basic zinc chloride is significantly reduced, which is in line with the sustainable development strategy of China.

Referring to the regulations of National Standard GB/T 22546-2008, the product basic zinc chloride prepared by the method of the present invention is detected for the zinc content, the chlorine content, the arsenic content, the lead content, and the cadmium content. The results show that, in the product basic zinc chloride prepared by the method of the present invention, the zinc content may be up to 58% to 60%, the chlorine content may be up to 12% to 12.8%, the arsenic content is lower than 5 ppm, the lead content is lower than 5 ppm, the cadmium content is lower than 8 ppm, which fully comply with national standards for feed grade basic zinc chloride, so the finished basic zinc chloride prepared by the method of the present invention can be directly used as feed additive.

### BRIEF DESCRIPTION OF THE DRAWINGS

The disclosure will become more fully understood from the detailed description given herein below for illustration only, and thus are not limitative of the disclosure, and wherein:

FIG. 1 is an XRD pattern of the product prepared in Example 3 of the present invention.

### DETAILED DESCRIPTION

The present invention is further described in detail below with reference to the accompany drawing, and the following embodiments are used for illustration of the present invention, but not intended to limit the present invention.

Basic zinc chloride of the present invention is prepared according to the method below:

First, a zinc chloride solution having a zinc concentration of 10 to 200 g/l and a calcium hydroxide suspension having a mass fraction of calcium hydroxide of 3% to 60% are respectively formulated, and added to a reactor in pair at the same time with stirring for reaction, where the stirring rate is 10 to 300 r/min, the reaction temperature is controlled at 20° C. to 100° C., and the pH value is controlled at 4 to 7. After addition in pair, the reactants are aged for 20 min to 90 min, to obtain the reaction product, and the reaction product is filtered, washed with water and dried, to obtain basic zinc chloride. The filtration may be filter pressing or centrifugal filtration, and the drying temperature is generally selected to be in the range of 70° C. to 120° C.

### Embodiment 1

In this embodiment, basic zinc chloride was prepared according to the method below:

First, a zinc chloride solution containing 50 g/l zinc was formulated from reagent-grade zinc chloride, a suspension containing 10% calcium hydroxide was formulated from reagent-grade calcium hydroxide or reagent-grade calcium oxide, 100 ml distilled water was added into the reactor, and the stirring device was then turned on. At the same time, the temperature was raised to 85° C., and then, 400 ml zinc chloride solution and 300 ml calcium hydroxide suspension were then added dropwise in pair into the reactor at the same time, the pH value was controlled at 4 to 5, the reactants were aged for 60 min after addition, and the product was filtered, washed, and dried at 100° C., pulverized and sieved by a 75-mesh sieve, to finally obtain the finished product.

The crystal composition and structure of the finished product were detected by an XRD detection method, and the XRD pattern of the finished product consisted with the standard pattern, so it was determined that the finished product was basic zinc chloride. At the same time, referring to the regulations of National Standard GB/T 22546-2008, the zinc content, the chlorine content, the arsenic content, the lead content and the cadmium content of the finished product were detected, and the detection results were: the zinc content: 59.8%, the chlorine content: 12.6%, the arsenic content: 1.4 ppm, the lead content: 2.3 ppm, and the cadmium content: 1.6 ppm, and all the contents complied with national standards for feed grade basic zinc chloride.

### Embodiment 2

In this embodiment, basic zinc chloride was prepared according to the method below:

First, a zinc chloride solution containing 65 g/l was formulated from reagent-grade zinc chloride, a qualified suspension containing 20% calcium hydroxide was formulated from hydrated lime (or quick lime) through slaking, purifying and removal of residue, 100 ml distilled water was added into the reactor, and the stirring device was then turned on. At the same time, the temperature was raised to 50° C., and then, 200 ml zinc chloride solution and 100 ml supernatant of the calcium hydroxide suspension were then added dropwise in pair into the reactor at the same time, the pH value was controlled at 5.0 to 6.0, the reactants were aged for 45 min after addition, and the product was filtered, washed, and dried at 100° C., pulverized and sieved by a 75-mesh sieve, to finally obtain the finished product.

The crystal composition and structure of the finished product were detected by an XRD detection method, and the XRD pattern of the finished product consisted with the standard pattern, so it was determined that the finished product was basic zinc chloride. At the same time, referring to the regulations of National Standard GB/T 22546-2008, the zinc content, the chlorine content, the arsenic content, the lead content and the cadmium content of the finished product were detected, and the detection results were: the zinc content: 58.8%, the chlorine content: 12.4%, the arsenic content: 2.3 ppm, the lead content: 3.2 ppm, and the cadmium content: 2.7 ppm, and all the contents complied with national standards for feed grade basic zinc chloride.

### Embodiment 3

In this embodiment, basic zinc chloride was prepared according to the method below:

ZnCl₂ was prepared with waste zinc and soot zinc oxide dust as raw materials through hydrochloric acid leaching, after removal of impurities, a zinc chloride solution having a zinc content of 100 g/l was obtained, a qualified suspension containing 15% calcium hydroxide was formulated from hydrated lime through slaking, purifying and removal of residue, 100 ml distilled water was added into the reactor, and the stirring device was then turned on. At the same time, the temperature was maintained at 25° C., 500 ml zinc chloride solution and 500 ml calcium hydroxide suspension were then added dropwise in pair into the reactor at the same time, the pH value was controlled at 5.5 to 6.5, the reactants were aged for 90 min after addition, and the product was filtered, washed, and dried at 100° C., pulverized and sieved by a 75-mesh sieve, to finally obtain the finished product.

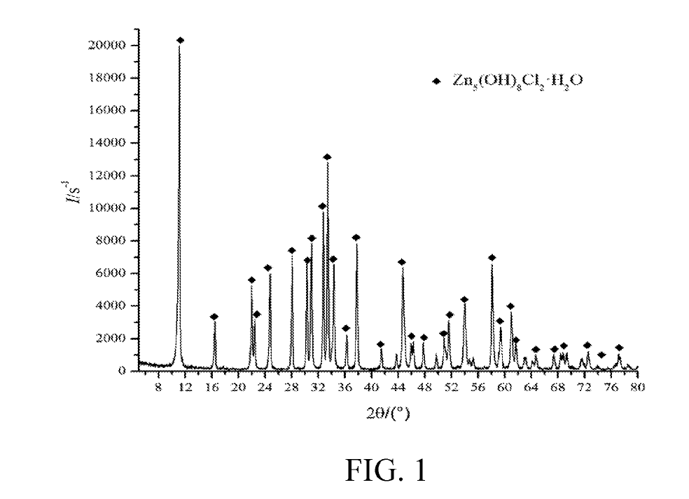

The crystal composition and structure of the finished product were detected by an XRD detection method, and the XRD pattern (see FIG. 1) of the finished product consisted with the standard pattern, so it was determined that the finished product was basic zinc chloride. At the same time, referring to the regulations of National Standard GB/T 22546-2008, the zinc content, the chlorine content, the arsenic content, the lead content and the cadmium content of the finished product were detected, and the detection results were: the zinc content: 58.2%, the chlorine content: 12.1%, the arsenic content: 3.6 ppm, the lead content: 4.2 ppm, and the cadmium content: 3.7 ppm, and all the contents complied with national standards for feed grade basic zinc chloride.

### Embodiment 4

In this embodiment, basic zinc chloride was prepared according to the method below:

ZnCl₂ was prepared with waste zinc and soot zinc oxide dust as raw materials through hydrochloric acid leaching, after removal of impurities, a zinc chloride solution having a zinc content of 120 g/l was obtained, a qualified suspension containing 10% calcium hydroxide was formulated from hydrated lime through slaking, purifying and removal of residue, 100 ml distilled water was added into the reactor, and the stirring device was then turned on. At the same time, the temperature was raised to 70° C., 500 ml zinc chloride solution and 500 ml calcium hydroxide suspension were then added dropwise in pair into the reactor at the same time, the pH value was controlled at 6.0 to 7.0, the reactants were aged for 90 min after addition, and the product was filtered, washed, and dried at 120° C., pulverized and sieved by a 75-mesh sieve, to finally obtain the finished product.

The crystal composition and structure of the finished product were detected by an XRD detection method, and the XRD pattern of the finished product consisted with the standard pattern, so it was determined that the finished product was basic zinc chloride. At the same time, referring to the regulations of National Standard GB/T 22546-2008, the zinc content, the chlorine content, the arsenic content, the lead content and the cadmium content of the finished product were detected, and the detection results were: the zinc content: 58.5%, the chlorine content: 12.5%, the arsenic content: 4.2 ppm, the lead content: 2.5 ppm, and the cadmium content: 3.1 ppm, and all the contents complied with national standards for feed grade basic zinc chloride.

### Embodiment 5

In this embodiment, basic zinc chloride was prepared according to the method below:

ZnCl₂ was prepared with waste zinc and soot zinc oxide dust as raw materials through hydrochloric acid leaching, after removal of impurities, a zinc chloride solution having a zinc content of 150 g/l was obtained, a qualified suspension containing 20% calcium hydroxide was formulated from hydrated lime through slaking, purifying and removal of residue, 100 ml distilled water was added into the reactor, and the stirring device was then turned on. At the same time, the temperature was raised to 95° C., 500 ml zinc chloride solution and 500 ml calcium hydroxide suspension were then added dropwise in pair into the reactor at the same time, the pH value was controlled at 5.0 to 6.5, the reactants were aged for 90 min after addition, and the product was filtered, washed, and dried at 100° C., pulverized and sieved by a 75-mesh sieve, to finally obtain the finished product.

The crystal composition and structure of the finished product were detected by an XRD detection method, and the XRD pattern of the finished product consisted with the standard pattern, so it was determined that the finished product was basic zinc chloride. At the same time, referring to the regulations of National Standard GB/T 22546-2008, the zinc content, the chlorine content, the arsenic content, the lead content and the cadmium content of the finished product were detected, and the detection results were: the zinc content: 58.6%, the chlorine content: 12.3%, the arsenic content: 2.2 ppm, the lead content: 4.6 ppm, and the cadmium content: 3.8 ppm, and all the contents complied with national standards for feed grade basic zinc chloride.

### Embodiment 6

In this embodiment, basic zinc chloride was prepared according to the method below:

ZnCl₂ was prepared with zinc dross as raw material through hydrochloric acid leaching, after removal of impurities, a zinc chloride solution having a zinc content of 10 g/l was obtained, a qualified suspension containing 3% calcium hydroxide was formulated from hydrated lime through slaking, purifying and removal of residue, 100 ml distilled water was added into the reactor, and the stirring device was then turned on. At the same time, the temperature was raised to 40° C., 500 ml zinc chloride solution and 500 ml calcium hydroxide suspension were then added dropwise in pair into the reactor at the same time, the pH value was controlled at 4.5 to 6.0, the reactants were aged for 20 min after addition, and the product was filtered, washed, and dried at 70° C., pulverized and sieved by a 75-mesh sieve, to finally obtain the finished product.

The crystal composition and structure of the finished product were detected by an XRD detection method, and the XRD pattern of the finished product consisted with the standard pattern, so it was determined that the finished product was basic zinc chloride. At the same time, referring to the regulations of National Standard GB/T 22546-2008, the zinc content, the chlorine content, the arsenic content, the lead content and the cadmium content of the finished product were detected, and the detection results were: the zinc content: 59.6%, the chlorine content: 12.0%, the arsenic content: 2.9 ppm, the lead content: 3.9 ppm, and the cadmium content: 2.8 ppm, and all the contents complied with national standards for feed grade basic zinc chloride.

### Embodiment 7

In this embodiment, basic zinc chloride was prepared according to the method below:

ZnCl₂ was prepared with secondary zinc oxide dust as raw material through hydrochloric acid leaching, after removal of impurities, a zinc chloride solution having a zinc content of 200 g/l was obtained, a qualified suspension containing 60% calcium hydroxide was formulated from hydrated lime through slaking, purifying and removal of residue, 100 ml distilled water was added into the reactor, and the stirring device was then turned on. At the same time, the temperature was raised to 100° C., 500 ml zinc chloride solution and 500 ml calcium hydroxide suspension were then added dropwise in pair into the reactor at the same time, the pH value was controlled at 5.5 to 7.0, the reactants were aged for 90 min after addition, and the product was filtered, washed, and dried at 100° C., pulverized and sieved by a 75-mesh sieve, to finally obtain the finished product.

The crystal composition and structure of the finished product were detected by an XRD detection method, and the XRD pattern of the finished product consisted with the standard pattern, so it was determined that the finished product was basic zinc chloride. At the same time, referring to the regulations of National Standard GB/T 22546-2008, the zinc content, the chlorine content, the arsenic content, the lead content and the cadmium content of the finished product were detected, and the detection results were: the zinc content: 60.0%, the chlorine content: 12.8%, the arsenic content: 1.9 ppm, the lead content: 2.7 ppm, the cadmium content: 2.0 ppm, and all the contents complied with national standards for feed grade basic zinc chloride.

### Embodiment 8

In this embodiment, basic zinc chloride was prepared according to the method below:

ZnCl₂ was prepared with waste zinc as raw material through hydrochloric acid leaching, after removal of impurities, a zinc chloride solution having a zinc content of 30 g/l was obtained, a qualified suspension containing 40% calcium hydroxide was formulated from hydrated lime through slaking, purifying and removal of residue, 100 ml distilled water was added into the reactor, and the stirring device was then turned on. At the same time, the temperature was raised to 20° C., 500 ml zinc chloride solution and 500 ml calcium hydroxide suspension were then added dropwise in pair into the reactor at the same time, the pH value was controlled at 5.0 to 6.0, the reactants were aged for 60 min after addition, and the product was filtered, washed, and dried at 120° C., pulverized and sieved by a 75-mesh sieve, to finally obtain the finished product.

The crystal composition and structure of the finished product were detected by an XRD detection method, and the XRD pattern of the finished product consisted with the standard pattern, so it was determined that the finished product was basic zinc chloride. At the same time, referring to the regulations of National Standard GB/T 22546-2008, the zinc content, the chlorine content, the arsenic content, the lead content and the cadmium content of the finished product were detected, and the detection results were: the zinc content: 58.0%, the chlorine content: 12.3%, the arsenic content: 3.2 ppm, the lead content: 3.3 ppm, the cadmium content: 3.2 ppm, and all the contents complied with national standards for feed grade basic zinc chloride.

1. A method for preparing basic zinc chloride from zinc chloride and calcium hydroxide through reaction.

2. The method for preparing basic zinc chloride according to claim 1, wherein the reaction temperature of the reaction is 20° C. to 100° C., and the pH value is 4 to 7.

3. The method for preparing basic zinc chloride according to claim 2, wherein the reaction temperature of the reaction is 40° C. to 100° C., and the pH value is 5 to 6.

4. The method for preparing basic zinc chloride according to claim 1, wherein the molar ratio of zinc chloride and calcium hydroxide is 4.5 to 5.5:4.

5. The method for preparing basic zinc chloride according to claim 4, wherein zinc chloride useful in the reaction is a zinc chloride solution having a zinc concentration of 10 to 200 g/l.

6. The method for preparing basic zinc chloride according to claim 5, wherein zinc chloride useful in the reaction is a zinc chloride solution having a zinc concentration of 50 to 150 g/l.

7. The method for preparing basic zinc chloride according to claim 5, wherein the zinc chloride solution is obtained from a zinc-containing industrial waste through hydrochloric acid leaching and removal of impurities.

8. The method for preparing basic zinc chloride according to claim 4, wherein calcium hydroxide useful in the reaction is a calcium hydroxide suspension having a mass fraction of calcium hydroxide of 3% to 60%.

9. The method for preparing basic zinc chloride according to claim 8, wherein calcium hydroxide useful in the reaction is a calcium hydroxide suspension having a mass fraction of calcium hydroxide of 10% to 20%.

10. The method for preparing basic zinc chloride according to claim 8, wherein the calcium hydroxide suspension is obtained from hydrated lime or quick lime through slaking, purification, separation and removal of residues, or the calcium hydroxide suspension is an intermediate product of the production of precipitated calcium carbonate.
